(19) United States
(12) Patent Application Publication
(10) Pub. No.: US 2008/0253723 A1
(43) Pub. Date: Oct. 16, 2008

(54) Optical fiber ribbon drop cable

(75) Inventors: Stephen R. Stokes, Raleigh, NC (US); Robert J. Andrews, Apex, NC (US); Patrick S. Van Vickle, Apex, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: SUMITOMO ELECTRIC LIGHTWAVE CORP.

(21) Appl. No.: 11/786,433

(22) Filed: Apr. 11, 2007

(51) Int. Cl. G02B 6/44

(52) U.S. Cl. 385/114

(57) ABSTRACT

A ribbon drop cable is provided. The ribbon drop cable includes a ribbon band of a plurality of communication medium. The ribbon band having a top flattened portion, a bottom flattened portion, a first side and a second side. At least one dielectric strength rod is disposed proximal to either the first side or second side of the ribbon band. The ribbon drop cable further includes a sheath which surrounds the ribbon band and the strength elements. The sheath is configured to hold the strength elements and the ribbon band in alignment.

### TECHNICAL FIELD

The subject matter described herein relates generally to optical fiber drop cables. More particularly, subject matter disclosed herein relates to ribbon drop cables that can transmit data, computer, and/or telecommunication information.

### BACKGROUND

Ribbon cables are cables with many conducting wires running parallel to each other on the same flat plane. As a result, the cable is wide and flat rather than round. Ribbon cables are commonly used for internal peripherals in the computers, such as hard drives, CD drives, and floppy drives. Ribbon cables allow for mass termination to specially designed insulation displacement connectors in which the ribbon cables are forced into a row of sharp fork contacts. Most commonly, this is done at both ends of the cable, though sometimes only one end will be terminated using insulation displacement connectors with the other end being terminated in a regular crimp or solder bucket connection. Ribbon cables can contain either copper wiring or optical fibers to transmit information and data between the components to which they are connected. Ribbon cables containing ribbons of optical fiber waveguides also benefit from mass termination methods. Optical fiber ribbons may be interconnected using mass fusion splicing methods or mass mechanical connection methods.

Communication networks which are used to transport a variety of signals such as voice, video, data transmission and the like, have historically been made of copper wires and cables for transporting information and data. However, copper wires have drawbacks because they are large, heavy and can transmit a relatively limited amount of data. On the other hand, an optical waveguide cable is capable of transmitting an extremely large amount of bandwidth as compared with copper conductor. Moreover, an optical waveguide cable is much lighter and smaller when compared with an equivalent copper cable having the same bandwidth capacity. Consequently, optical waveguide cables have replaced most copper cables in long-haul communication network links, thereby providing greater bandwidth capacity for long-haul links. More recently, optical waveguide cables are replacing copper cables within the local access network to facilitate the introduction of broadband services such as internet access and various video entertainment services to subscribers. As a result, demand for fiber to the home is increasing for single family and multi-family homes.

These optical waveguide cables are usually a bundle of optical fibers that are typical gathered together within a cylindrical housing. Therefore, when the optical waveguide cables are spliced, these fibers must be spliced one at a time. Since these optical waveguide cables are constructed of a plurality of fibers, the splicing of the cable can be time-consuming.

Compared to traditional waveguide cables, ribbon cables contain optical fiber ribbons which are referenced herein as ribbon bands, can be easily mass spliced. Mass splicing gives the ability to the installer to connect ends of ribbon bands and the fibers contained therein without having to individually splice each pairing of fibers contained within the ends of the two ribbons. Mass splicing of ribbon bands can be done in a relatively short amount of time thereby increasing the efficiency of installation when using such ribbons in communication networks.

Therefore, in light of the above, a long-felt need exists for a ribbon drop cable that provides protection and strength for the internal ribbon band while still providing easy accessibility to the ribbon cable for mass splicing.

### SUMMARY

In accordance with this disclosure, novel ribbon drop cables for use in communication networks are provided.

The present disclosure provides ribbon drop cables that provide strength and protection to the ribbon band disposed within the outer housing of the cabling, while providing easy access to the ribbon band for mass splicing and fast installation. This and other purposes as may become apparent from the present disclosure can be achieved, in whole and in part, by the presently disclosed subject matter when taken in connection with the accompany drawings as best described herein below.

### BRIEF DESCRIPTION OF THE DRAWINGS

A full and enabling disclosure of the present subject matter including the best mode thereof to one of ordinary skilled in the art is set forth more particularly in the remainder of the specification, including references to the accompany figures in which:

FIG. 1 illustrates a perspective view of an embodiment of a ribbon drop cable according to the present subject matter;

FIG. 2 illustrates a cross-sectional view of the embodiment of the ribbon drop cable according to FIG. 1 taken along the lines I-I of FIG. 1;

FIG. 3 illustrates an enlarged cross-sectional view of a portion of another embodiment of a ribbon drop cable according to the present subject matter; and

FIG. 4 illustrates a cross-sectional view of a further embodiment of a ribbon drop cable according to the present subject matter.

### DETAILED DESCRIPTION

Reference will now be made in detail to the presently preferred embodiments of the present subject matter, one or more examples of which are shown in the Figures. Each example is provided to explain the subject matter and not as a limitation. In fact, features illustrated or described as part of one embodiment can be used in another embodiment to yield still a further embodiment. It is intended that the present subject matter cover such modifications and variations.

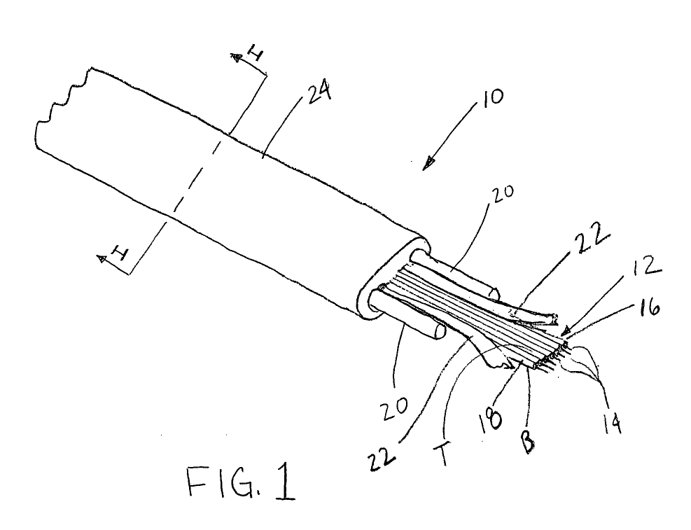

FIG. 1 illustrates a ribbon drop cable, generally designated as 10. The ribbon drop cable 10 includes a ribbon band 12 containing a plurality of communication medium such as optical fibers 14. The optical fibers 14 are aligned adjacent to one another side by side, thereby forming a planar ribbon band that is wide but thin. Ribbon band 12 includes a first side 16 and a second side 18. The ribbon drop cable 10 includes a sheath 24 that surrounds and encloses ribbon band 12. On either side 16, 18 of the ribbon band 12, strength elements 20 are contained within the sheath 24. Strength elements 20 add both tensile and compression strength to ribbon drop cable 10 and protect the ribbon band 12 that is positioned between the two strength elements 20. Strength elements 20 have a density that prevents unintentional cutting. Strength elements 20 can comprise dielectric material. For example, the strength elements 20 can be dielectric rods of fiberglass or fiber reinforced plastic (FRP).

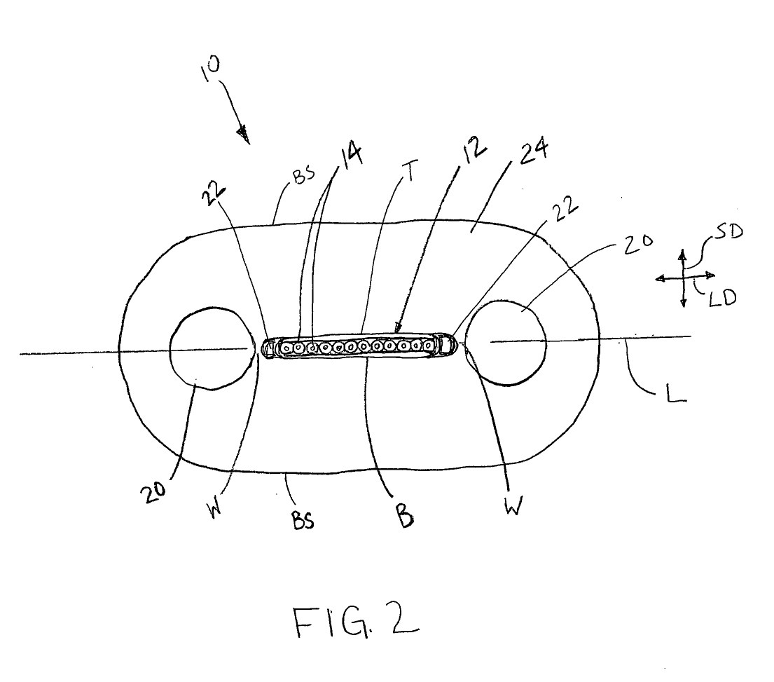

Multiple strength elements 20 may be inserted within ribbon drop cable 10. For example, in the embodiment shown in FIGS. 1 and 2, two strength elements are used. As described above, the strength elements 20 are positioned on either side 16, 18 of ribbon band 12. However, other numbers of strength rods can be used within ribbon drop cable 10. For instance, four strength rods may be positioned around the ribbon band with one on either side of the ribbon band and one placed above the ribbon band and one placed below the ribbon band within the drop cable.

Strength elements 20 can extend generally linearly and add enough rigidity to the cable to allow the ribbon drop cable 10 to be inserted over lengthy distances within conduits and other installations. At the same time, strength elements 20 permit ribbon drop cable 10 to bend as necessary to permit ease of installation, while still protecting ribbon band 12 and its fibers 14 from damage. For example, strength elements 20 will permit ribbon drop cable 10 to turn as the conduit in which it is being installed turns.

Ribbon drop cable 10 may also include water-blocking strength yarns 22 disposed within sheath 24 at positions around the ribbon band 12. The water-blocking strength yarns 22 may absorb water or swell on contact with water to block ingress along the length of the drop cable 10. The water-blocking yarns 22 can also increase the overall strength of ribbon drop cable 10. In particular, the water-blocking yarns 22 can increase the tensile strength of ribbon drop cable 10. The water-blocking yarns 22 can comprise glass fibers housed within a flexible matrix with a water swellable coating. The water-blocking yarns 22 can also comprise yarns of manmade fibers such as polyester, polypropylene, polyethylene, polyamides, or other thermoplastic polymers. These thermoplastic yarns may be treated to increase their absorbance. The water-blocking yarns 22 can also comprise water-absorbing material such as cotton, rayon, or the like. Water-blocking yarns 22 can be monofilament yarns. For example, yarns 22 can be ribbon, or tape, yarns. Strength yarns 22 can also be multifilament yarns, or spun yarns.

The water-blocking yarns 22 can be positioned with the sheath 24 at different locations around the ribbon band 12. For example, as shown in FIGS. 1 and 2, the water-blocking yarns 22 may be positioned on either side 16 or 18 of ribbon band 12 between the ribbon band 12 and the strength elements 20. Further, the water-blocking yarns 22 may be positioned above the flattened top portion T of ribbon band 12 and below flattened bottom portion B of ribbon band 12. Water-blocking yarns 22 may surround the ribbon band 12. For example, water-blocking yarns 22 can be positioned above the flattened top portion T of ribbon band 12 and below flattened bottom portion B of ribbon band 12 and on the side 16, 18 of the ribbon band 12.

Ribbon drop cable 10 further includes a sheath 24 which surrounds ribbon band 12 as well as strength elements 20 and water-blocking yarns 22. Sheath 24 can abut against ribbon band 12 on at least one side of ribbon band 12. For example, sheath 24 can abut against all sides of ribbon band 12. Sheath 24 includes a thermoplastic polymer which surrounds the components of ribbon drop cable 10 used to protect the ribbon band 12 of fibers 14. The sheath 24 has a protective thickness that extends over both top flattened portion T and the bottom flattened portion B of ribbon band 12.

The dimensions of ribbon drop cable 10 and the sheath thickness at various point within ribbon drop cable 10 can vary depending on the type of material used for the sheath. The sheath material should be UV stabilized. The sheath material can comprise polyethylene compounds, such as medium density polyethylene (MDPE), high density polyethylene (HDPE), linear low density polyethylene (LLDPE), or the like. Also, the sheath material can comprise flame-retardant polyethylenes, PVC compounds, or the like. The mechanical characteristics desired of sheath 24 will drive the type of materials used and the dimensions of ribbon drop cable 10.

A cross-sectional view of ribbon drop cable 10 is shown in FIG. 2. The ribbon drop cable 10 has a width that extends in long axial direction LD along a long axis L and a height that extends in the short axial direction SD. The width of ribbon drop cable 10 can be generally greater than the height of ribbon drop cable 10. For example, the width of ribbon drop cable 10 can be about 8 mm and the height of ribbon drop cable 10 can be about 5 mm. However, the width and height of ribbon drop cable 10 can vary greatly depending on the end use of ribbon drop cable 10 and the type of materials and structures used in ribbon drop cable 10. The strength elements 20 and ribbon band 12 can be aligned within sheath 24 along the long axis L of the ribbon drop cable 10 such that heights of portions of strength elements 20 extend above the top flattened portion T of ribbon band 12 and bottom flattened portion B of band 12 in the short axial direction SD, as will be described in more detail below. In this manner, strength elements 20 add strength to ribbon drop cable 10 and provide protection to not only sides 16 and 18 of ribbon band 12 but also to the top portion T and bottom portion B of ribbon band 12. The strength elements 20 thereby provide protection to the ribbon band when a compressive load is applied to the top and bottom surfaces of the drop cable.

In the embodiment shown in FIGS. 1 and 2, strength elements 20 have a circular cross-section. However, strength elements 20 can have other cross-sectional shapes, while still increasing the strength of ribbon drop cable 10 and the protection of ribbon band 12. For example, the strength elements can have a square, rectangle, elliptical, hexagonal, octagonal, or non-symmetrical cross-section or the like.

Between each strength element 20 and ribbon band 12, a web W is formed by sheath 24 (see FIG. 2). The webs W allow for easy separation of strength elements 20 from the ribbon band 12 and easy separation of ribbon band 12 from sheath 24. The webs W between the strength elements 20 and the ribbon band 12 are thin enough to allow easy peeling of sheath 24 away from strength elements 20 and ribbon band 12. The webs W should be thick enough to provide at least minimal separation between the ribbon band 12 and strength elements 20.

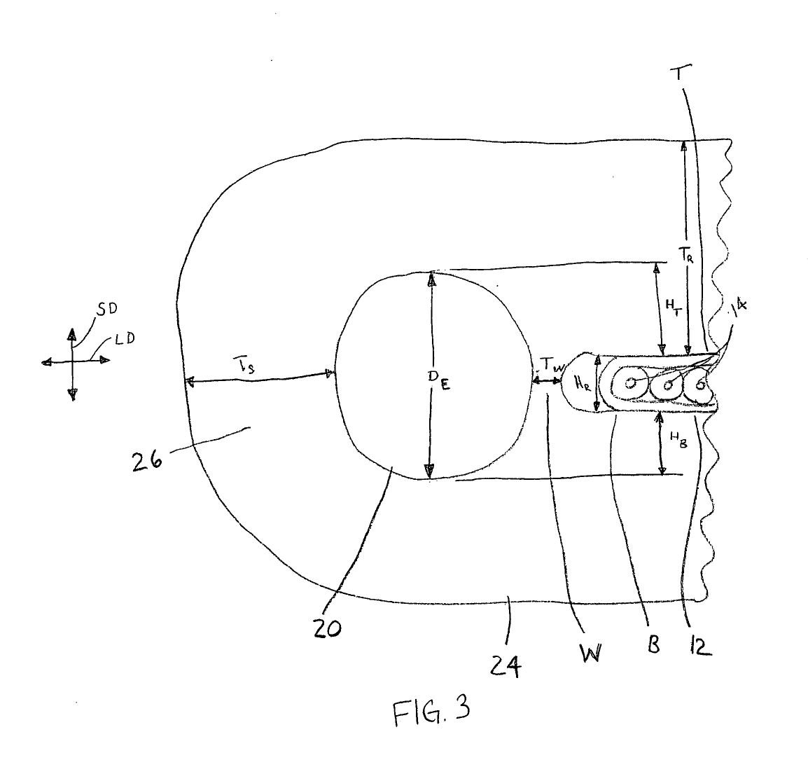

FIG. 3 illustrates a portion of a ribbon drop cable, generally designated as 10. Ribbon drop cable 10 includes a sheath 24 that houses a ribbon band 12 and two strength elements 20 (one of which is not shown). The strength elements can be coated with a water-absorbing compound, instead of or in addition to having the water-blocking yarns (not shown in FIG. 3) being included in the ribbon drop cable 10. The water-absorbing compound can aid in preventing water entering the sheath and interfering with the functionality of the fibers 14 in ribbon band 12.

The sheath 24 can form a web W between each strength element 20 and ribbon band 12. The web W between each strength element 20 and ribbon band 12 has a thickness T_{w} that permits easy separation of the sheath 24 from the strength elements 20 and the ribbon band 12. At the same time, the thickness T_{w} of web W is great enough to prevent the web from breaking down during handling and installation. The web W can thus prevent strength elements 20 from contacting the ribbon band 12 and from damaging the fibers 14 contained within the ribbon band 12. In some embodiments, the thickness T_{w} may be between about 0.2 mm and about 0.5 mm. The thickness T_{w} of the web W can depend on the type of material used in the sheath 24.

Sheath 24 can have side portions 26 that create an outer sheath thickness Tₛ along strength elements 20 that protect the ribbon drop cable from damage and to prevent unintentional access to strength elements 20 but that can then be separated from the ribbon drop cable 10, thereby providing access to the ribbon band 12. The thickness Tₛ of the side portions 26 of sheath 24 can depend on the type of material used in the sheath 24. To gain access to strength elements 20, the side portions 26 of sheath 24 can be cut along and within the thickness Tₛ. Since the strength elements 20 provide a buffer to the ribbon band 12, a knife or other cutting instrument can be used to cut along the sides of the ribbon drop cable 10 without fear of unintentionally cutting the ribbon band 12. The cutting instrument may cut into the strength element 20, but should not cut through the strength element 20. In this manner, the ribbon band 12 is prevented from being unintentionally cut while separating of the strength elements 20 from ribbon drop cable 10 during installation.

Sheath 24 can also create an inner sheath thickness T_{R} above ribbon drop cable 10 that can be greater than outer sheath thickness Tₛ. For example, the inner sheath thickness T_{R} can be about 1.5 mm and the outer sheath thickness Tₛ can be about 1.0 mm. As stated previous, such dimensions can vary widely depending on the end use of ribbon drop cable 10 and the type of materials and structures used in ribbon drop cable 10.

Once access is gained to strength elements 20 by cutting the side portions 26 of the sheath 24, strength elements 20 can be peeled outward along the ribbon drop cable 10 to a desired location. Strength elements 20 are strong enough to withstand the forces produced by the resistance against the tearing of sheath 24 created during the peeling process. At the same time, the thickness Tₛ of side portions 26 is thin enough to permit this peeling once access to strength elements 20 is gained.

As shown in FIG. 3, strength elements 20 can have a cross-sectional distance D_{E} that is greater than the height H_{R} of the ribbon band 12. As stated above, strength elements 20 can comprise any appropriate cross-sectional shape. The cross-sectional distance D_{E} as used herein is measured along a line within the largest cross-sectional portion of a strength element 20 that is perpendicular to the long axis L of the ribbon drop cable 10 that extends in the long axial direction LD as seen in FIG. 2. Thus, when strength elements 20 are aligned with the ribbon band 12 within the sheath 24, a portion of each strength element 20 extends at a height H_{T} above the top flattened portion T of the ribbon band 12 and a portion of each strength element 20 extends at a height H_{B} below the bottom flattened portion B of the ribbon band 12 as measured in the short axial direction SD.

In this manner, strength elements 20 add a buffer protection to the ribbon band 12 both above and below the ribbon band 12 without actually physically extending over the top flattened portion T of the ribbon band 12 or the bottom flattened portion B of the ribbon band 12. The cross-sectional distance D_{E} of the strength elements 20 is large enough to prevent accidental tearing of the ribbon drop cable 10, while still permitting the bending of the ribbon drop cable 10 for ease of installation. The density of strength elements 20 and their cross-sectional distances D_{E} provide strength points on either side of the ribbon band 12. Also, since strength elements 20 extend at a height H_{T} above the top flattened portion T and extend at a height H_{B} below the bottom flattened portion B, protection is provided to the ribbon band 12 against blunt force on the broad side BS of the sheath 24 (see FIG. 2). Support is thus provided above and below the ribbon band 12 which further protects the ribbon band 12 from damage due to compressive and impact forces.

The strength elements 20 and the ribbon band 12 can be centered along the long axis L of the ribbon drop cable 10 such that the height H_{T} of each strength element 20 that extends above and the height H_{B} of each strength element 20 that extends below the ribbon band 12 are equal. Alternatively, the strength elements 20 and the ribbon band 12 can be positioned within the ribbon drop cable 10 such that the height H_{T} of each strength element 20 that extends above and the height H_{B} of each strength element 20 that extends below the ribbon band 12 are unequal.

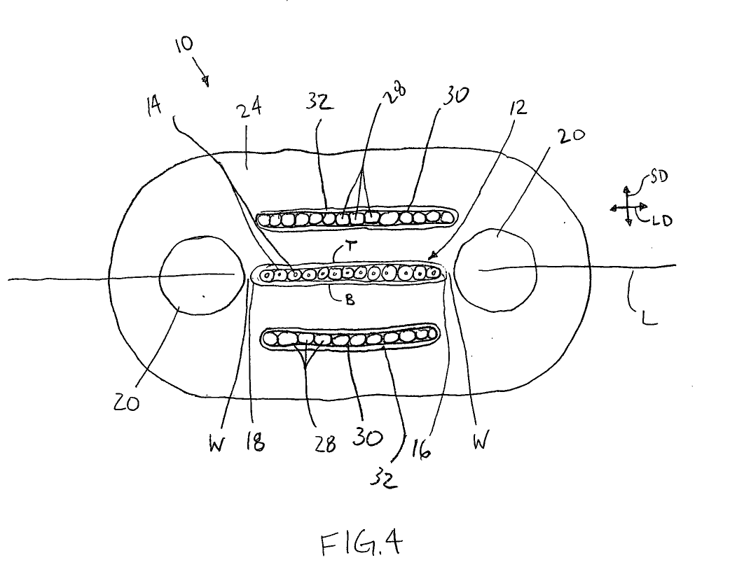

FIG. 4 shows a cross-section of a further embodiment of a ribbon drop cable, generally designated as 10. Similar to the embodiments described above, ribbon drop cable 10 includes a ribbon band 12 containing a plurality of communication medium such as optical fibers 14. The optical fibers 14 are aligned adjacent to one another side by side, thereby forming a planar ribbon band that is wider than it is thick. Ribbon band 12 includes a first side 16 and a second side 18. Ribbon drop cable 10 includes a sheath 24 that surrounds and encloses ribbon band 12. On either side 16, 18 of the ribbon band 12, strength elements 20 are contained within the sheath 24 with sheath 24 forming a web W between each strength element 20 and ribbon band 12. Ribbon drop cable 10 further includes glass filaments 28 arranged in a planar ribbon 30 above a top flattened portion T of ribbon band 12 and a bottom flattened portion B of band 12.

Planar ribbon 30 of glass filaments 28 can be enveloped with a polymer coating 32 which can be then coated with a thin water swellable compound applied to the outer surface of the polymer coating 32. The ribbon 30 of glass filaments 28 can have similar outer dimensions to that of fiber optic ribbon band 12. Ribbon drop cable 10 can use one ribbon 30 of glass filaments 28 above top flattened portion T of ribbon band 12 and one ribbon 30 of glass filaments 28 below bottom flattened portion B of the ribbon band 12 such that each ribbon 30 of glass filaments 28 has a width that extends in direction LD that is parallel to axis L that runs along the width of ribbon band 12 as shown in FIG. 4.

Such ribbons 30 of glass filaments 28 will provide water blocking characteristics to ribbon drop cable 10 and provide a buffer to ribbon band 12 from mechanical stresses of the outer sheath 24. Thus, ribbons 30 of glass filaments 28 operate as strength elements in a different form than strength elements 20 depicted in FIG. 4.

Using such ribbon drop cables as described above in association with FIGS. 1-4, mass installation and splicing can easily occur. Further, the cables can be easily entered into associated conduits or ducts, while maximizing the conduit or duct space. Further, these ribbon drop cables can be easily sealed in closures and provide clean gel-free dry designs that are insensitive to bending.

Such ribbon drop cables 10 provide a FTTx ribbon drop cable. FTTx stands for Fiber-to-the-x, where “x” is the acronym that represents the end location of the optical waveguide. For instance, FTTC is “fiber to the curve” and FTTP represents “fiber to the premises.” The FTTx architecture is beneficial to an optical wave guide network because it extends the reach of the full bandwidth capability of the fiber network wherever optical fiber is installed, instead of relying on existing copper infrastructure. As the final link to the customer, the ribbon drop cable is compatible with hardened multi-fiber connectors, ideal for terminal tether, and used for both aerial and buried applications.

The ribbon drop cable can include standard ribbon or a new 3×4 modular ribbon configuration that facilitates quick deployment and mass splicing of 4-fiber branching FTTH/FTTP network topologies. Such a ribbon drop cable can be easily spliced using a mass fusion splicer for fast, lower cost, and more efficient FTTx deployments. For example, a TomCat™ (Type-25M) mass fusion splicer produced by Sumitomo, Inc., located in Research Triangle Park, NC, can be used to quickly splice the ribbon drop cables.

The embodiments of the present disclosure shown in the drawings and described above are exemplary of the numerous embodiments that can be made within the scope of the appending claims. It is contemplated that the configurations of a ribbon drop cable can comprise numerous configurations other than those specifically disclosed. The scope of a patent issuing from this disclosure will be defined by the appending claims.

What is claimed:

1. A ribbon drop cable comprising:
(a) a ribbon band of a plurality of communication media, the ribbon band having a top flattened portion, a bottom flattened portion, a first side and a second side;
(b) at least one strength element being disposed proximal to at least one of the first side or second side of the ribbon band; and
(c) a sheath which surrounds the ribbon band and the at least one strength element, the sheath being configured to hold the at least one strength element and the ribbon band in alignment.

2. The ribbon drop cable of claim 1, further comprising at least one water-blocking yarn disposed within the sheath.

3. The ribbon drop cable of claim 2 wherein the at least one water-blocking yarn is disposed between the at least one strength element and the ribbon band.

4. The ribbon drop cable of claim 2 wherein the at least one water-blocking yarn comprises a monofilament yarn, multifilament yarn, spun yarn or a glass fiber reinforced yarn.

5. The ribbon drop cable of claim 1 wherein the communication media are optical fibers.

6. The ribbon drop cable of claim 1 wherein the at least one strength element comprises two strength elements.

7. The ribbon drop cable of claim 6 wherein the strength elements have a cross-sectional distance that is larger than a height of the ribbon band.

8. The ribbon drop cable of claim 7 wherein the ribbon band is disposed between the strength elements within the sheath such that a portion of each strength element has a height that extends above the ribbon band and a portion of each strength element has a height that extends below the ribbon band in the short axial directions of the ribbon drop cable.

9. The ribbon drop cable of claim 1 wherein the at least one strength element comprises a dielectric material.

10. The ribbon drop cable of claim 1 wherein the sheath is configured to hold the strength elements and the ribbon band in alignment along a cross-sectional long axis of the ribbon drop cable.

11. The ribbon drop cable of claim 1 wherein the sheath forms a web between the at least one strength element and the ribbon band.

12. The ribbon drop cable of claim 11 wherein the web comprises a thickness between the strength element and the ribbon band that increases ease of removal of at least one of the strength element or the ribbon band from the ribbon drop cable, while preventing breakage of the web during handling of the drop cable.

13. The ribbon drop cable of claim 1 further comprises at least one additional strength element disposed within the sheath above the top flattened portion of the ribbon band or below the bottom flattened portion of the ribbon band.

14. The ribbon drop cable of claim 13 wherein the at least one additional strength element comprises a ribbon of glass filaments disposed within the sheath above the top flattened portion of the ribbon band and a ribbon of glass filaments disposed within the sheath below the bottom flattened portion of the ribbon band.

15. The ribbon drop cable of claim 14 wherein the ribbon of glass filaments are coated with a polymer coating that is then coated with a water swellable compound.

16. A ribbon drop cable comprising:
(a) a ribbon band of a plurality of optical fibers, the ribbon band having a top flattened portion, a bottom flattened portion, a first side and a second side;
(b) two strength elements with one strength element being disposed proximal to the first side and the other strength element being disposed proximal to the second side of the ribbon band;
(c) a sheath which surrounds the ribbon band and the strength elements, the sheath being configured to hold the strength elements and the ribbon band in alignment along a cross-sectional long axis of the ribbon drop cable; and
(d) at least one water-blocking yarn disposed adjacent the sheath.

17. The ribbon drop cable of claim 16 wherein the strength elements have a cross-sectional distance that is larger than the height of the ribbon band.

18. The ribbon drop cable of claim 17 wherein the ribbon band is disposed between the strength elements within the sheath such that a portion of each strength element has a height that extends above the ribbon band and a portion of each strength element has a height that extends below the ribbon band in the short axial directions of the ribbon drop cable.

19. The ribbon drop cable of claim 16 wherein the two strength elements comprise a dielectric material.

20. The ribbon drop cable of claim 16 wherein the sheath forms webs between the strength elements and the ribbon band.

21. The ribbon drop cable of claim 20 wherein the webs comprise a thickness between each strength element and the ribbon band that increases ease of removal of the strength elements or the ribbon band from the ribbon drop cable, while preventing breakage of the webs during handling of the drop cable.

22. The ribbon drop cable of claim 16 wherein the at least one water-blocking yarn comprises a monofilament yarn, multifilament yarn, glass filament ribbon or a spun yarn.

23. The ribbon drop cable of claim 16 further comprises at least one additional strength element disposed within the sheath above the top flattened portion of the ribbon band or below the bottom flattened portion of the ribbon band.

24. The ribbon drop cable of claim 23 wherein the at least one additional strength element comprises a ribbon of glass filaments disposed within the sheath above the top flattened portion of the ribbon band and a ribbon of glass filaments disposed within the sheath below the bottom flattened portion of the ribbon band.

25. A ribbon drop cable comprising:
(a) a ribbon band of a plurality of optical fibers, the ribbon band having a top flattened portion, a bottom flattened portion, a first side and a second side;
(b) two strength elements with one strength element being disposed proximal to the first side and the other strength element being disposed proximal to the second side of the ribbon band;
(c) a sheath which surrounds the ribbon band and the strength elements, the sheath being configured to hold the strength elements and the ribbon band in alignment along a cross-sectional long axis of the ribbon drop cable such that the ribbon band is centered between the strength elements within the sheath with a portion of each strength element having a height that extends above the ribbon band and a portion of each strength element having a height that extends below the ribbon band in the short axial directions of the ribbon drop cable;
(d) the sheath forming respective webs between the two strength elements and the ribbon band, the webs having a thickness between each strength element and the ribbon band that increases ease of removal of the strength elements or the ribbon band from the ribbon drop cable, while preventing breakage of the webs during handling of the drop cable; and
(e) at least one water-blocking yarn, the at least one water-blocking yarn being disposed within the sheath adjacent the ribbon band.
